(19) United States
(12) Patent Application Publication
(10) Pub. No.: US 2026/0323432 A1
(43) Pub. Date: Oct. 15, 2026

(54) SYSTEMS AND METHODS FOR USER EQUIPMENT FALLBACK TO NON-WAKE-UP RECEIVER OPERATION IN RADIO RESOURCE CONTROL CONNECTED

(71) Applicant: TELEFONAKTIEBOLAGET LM ERICSSON (PUBL), Stockholm (SE)

(72) Inventor: Andreas Höglund, SOLNA (SE)

(21) Appl. No.: 19/483,638

(22) PCT Filed: May 13, 2024
(86) PCT No.: PCT/IB2024/054642

§ 371 Date: Nov. 12, 2025

Related U.S. Application Data
(60) Provisional application No. 63/501,716, filed on May 12, 2023.

(51) Int. Cl. H04W 36/00; H04W 36/08; H04W 52/02

(52) U.S. Cl. CPC H04W 36/0085; H04W 36/08; H04W 52/0274

(57) ABSTRACT

A method performed by a user equipment, UE, while the UE is in a Radio Resource Control, RRC, connected state and is configured for Wake-up Receiver, WUR, includes performing at least one UE mobility measurement. Based on the at least one UE mobility measurement, the UE determines whether to perform WUR monitoring for a downlink channel.

### TECHNICAL FIELD

The present disclosure relates, in general, to wireless communications and, more particularly, systems and methods for User Equipment (UE) fallback to non-Wake-up Receiver (WUR) operation in Radio Resource Control (RRC) connected.

### BACKGROUND

Wake-up receiver (WUR) is sometimes also referred to as ‘wake-up radio’ and relates to enabling a low power receiver in User Equipments (UEs). When a wake-up signal (WUS) is detected, the main receiver, which may include a baseband/higher power receiver, wakes up to detect an incoming message. The incoming message is typically a paging message such as, for example, Physical Downlink Control Channel (PDCCH) in paging occasions (PO), which schedules the paging message on Physical Downlink Shared Channel (PDSCH). FIG. 1 illustrates a location of a WUS and the paging occasion to which it is associated. The main benefit of employing WUR is lower energy consumption and longer device battery life, or at a fixed energy consumption the downlink latency can be reduced (shorter Discontinuous Reception (DRX)/duty-cycles and more frequent checks for incoming transmissions).

### WUS for Narrowband-Internet of Things (NB-IoT) and Long Term Evolution-Machine Type Communications (LTE-M)

### Release 15

In Release 15 (Rel-15), WUS was specified for NB-IoT and LTE-M. The main motivation was UE energy consumption reduction since with the coverage enhancement PDCCH could be repeated many times and the WUS is relatively much shorter and thus requires less reception time for the UE. The logic is that a UE would check for a WUS a certain time before its PO. Only if a WUS is detected, the UE would continue to check for PDCCH in the PO. If a WUS is not detected, which is most of the time, the UE can go back to a sleep state to conserve energy. Due to the coverage enhancements the WUS can be of variable length depending on the UE's coverage. FIG. 2 illustrates WUS for NB-IoT and LTE-M.

A WUS is based on the transmission of a short signal that indicates to the UE that it should continue to decode the downlink (DL) control channel such as, for example, full Narrowband PDCCH (NPDCCH) for NB-IoT. If such signal is absent (such as, for example, Discontinuous Transmission (DTX) that the UE does not detect), then the UE can go back to sleep without decoding the DL control channel. The decoding time for a WUS is considerably shorter than that of the full NPDCCH since it essentially only needs to contain one bit of information, whereas the NPDCCH may contain up to 35 bits of information. This, in turn, reduces UE power consumption and leads to longer UE battery life. The WUS would be transmitted only when there is a paging for the UE. But if there is no paging for the UE, the WUS will not be transmitted (i.e., implying a DTX) and the UE would go back to deep sleep. This is illustrated in FIG. 1, where white blocks indicate possible WUS and PO positions whereas the black boxes indicate actual WUS and PO positions.

The specification of Rel-15 WUS is spread out over several parts of the LTE 36-series standard such as, for example, 3GPP TS 36.211, 3GPP TS 36.213, 3GPP TS 36.304 and 3GPP TS 36.331.

A UE will report its WUS capability to the network and WUS gap capability. Further, WUS information was added to the paging message/request from Mobility Management Entity (MME) to eNodeB (eNB). UE radio paging capabilities are discussed in more detail below. eNB will use WUS for paging the UE if 1) WUS is enabled in the cell (i.e., WUS-Config present in System Information (SI)), and 2) the UE supports WUS according to the wake UpSignal-r15 UE capability.

WUS was introduced for both LTE-M and NB-IoT with support for both DRX and Enhanced DRX (eDRX) with the possible configuration of 1-to-N (many) POs. eNB can configure one WUS gap for UEs using DRX, and another one for UEs using eDRX. 3GPP TS 36.331 provides a WUS-Config-NB Information element.

The UE capabilities can also indicate the minimum WUS gaps required for the UE to be able to decode PDCCH in the associated PO, for DRX and eDRX, respectively, as discussed in 3GPP TS 36.331.

At the end of Rel-15, a longer WUS gap of 1s or 2s was introduced to enable the use of WUR. That is, starting up the main baseband receiver if a WUR is used for the detection of WUS may take longer time. If this is supported in the cell, eNB would include timeOffset-eDRX-Long in the WUS-Config in SI. In 3GPP TS 36.304, the UE behavior for monitoring paging with WUS is specified, and in Table 7.4-1 it is indicated which WUS time gap the UE (and eNB) should apply depending on the reported UE capability.

In essence, the UE will only use WUR, or timeOffset-eDRX-Long, if it is capable of starting up the main receiver as quickly as indicated by the value used in SI. If not, it will fall back to using timeOffset-eDRX-Short (without WUR).

FIG. 3 illustrates the use of eDRX and DRX WUS gaps for NB-IoT and LTE-M. Since UEs share PO, the eNB may, in the worst case, have to transmit up to three WUSs for one PO such as, for example, corresponding to timeoffsetDRX, timeoffset-eDRX-Short, and timeoffset-eDRX-Long.

### WUS UE Grouping Objective in Release 16 (Rel-16)

In the Rel-16 Work Item Description (WID), it was agreed that WUS should be further developed to also include UE grouping, such that the number of UEs that are triggered by a WUS is further narrowed down to a smaller subset of the UEs that are associated with a specific paging occasion (PO):
The objective is to specify the following set of improvements for machine-type communications for BL/CE UEs.
Improved DL transmission efficiency and/or UE power consumption:
   . . .
   Specify support for UE-group wake-up signal (WUS) [RAN1, RAN2, RAN4]

The purpose is to reduce the false paging rate such as, for example, avoiding that a given UE is unnecessarily woken up by a WUS transmission intended for another UE. This feature is referred to as Rel-16 group WUS (GWUS). However, this is not directly related to WUR and will not further be explained here.

### Rel-17 NR Paging Early Indication (PEI)

In Rel-17 discussions started on introducing a WUS for NR, then called ‘Paging Early Indication’ (PEI). However, at the time no coverage enhancement was specified for NR. Thus, the only gain for Rel-17 PEI was for scenarios where the small fraction of UEs are in bad coverage and with large synchronization error due to the use of longer DRX cycles. The gain for such UEs were that with the use of PEI they would typically only have to acquire one Synchronization Signal Block (SSB) before decoding PEI, instead of up to three SSBs if PEI is not used. So, for most UEs, Rel-17 PEI will result in gains or increased performance.

Rel-17 PEI will also support UE grouping for false paging reduction, similar to the Rel-16 GWUS above, which will have some gains at higher paging load.

In RAN #93e, it was agreed that PEI will be PDCCH-based, making it much less interesting for WUR. For example, the main baseband receiver is required for decoding PEI.

### Release 18 (Rel-18) NR WUR

In Rel-18, there has been rather large interest to introduce WUR for NR. As explained above, the only specification support needed to be able to use a WUR in the UE, is the specification of a WUS and a long enough time gap between the WUS and the PDCCH in the PO (to allow the UE to start up the main receiver). Therefore, the main difference to Rel-17 PEI is the WUS in Rel-18 should not be PDCCH-based and allow for a simpler and low power receiver such as, for example, WUR with simple modulation and detection techniques (e.g., using on-off keying (OOK) modulation and non-coherent detection).

In Rel-18, a study item on “low-power wake-up signal and receiver for NR” was approved. The relevant justification and objective sections are discussed in RP-213645. See, RP-213645, “New SID: Study on low-power Wake-up Signal and Receiver for NR”, RAN plenary #94, Dec. 2021.

For more details and suggestions on WUR architecture and design, receiver power vs. sensitivity trade-off, see, for example, RP-212005, RP-212254, RP-212367, and RP-212427 which were submitted to RAN3 #93-e.

The benefit of WUR is to reduce the energy consumption of the receiver, such that unless there is any paging and data for the UE it can remain in a power saving state. This will extend the battery life of the device, or alternatively enable shorter downlink latency (shorter DRX) at a fixed battery life. For short-range communication, the WUR power can be low enough (~3 uW) that this can even, in combination with energy harvesting, enable that the WUR is continuously on (i.e., DRX or duty-cycling is not used) without the need for a battery. This can be considered as a key enabler of battery-less devices towards 6G.

### IEEE WUR

In IEEE, the support for WUR has been specified to a greater extent than in 3GPP. That is, the focus was on low power WUR from start and the design uses WUR not only for receiving the WUS but also other control signals and signaling, such as synchronization and mobility information. This allows the stations (corresponding to UEs in 3GPP) to only use the WUR when there is no user-plane data transmission ongoing.

Similar to the 3GPP solution, the use of WUR is only enabled in stations and not in access points (APs), that is for downlink communication only. The AP advertises that it has WUR operation capability, along with WUR configuration parameters (among other info, in which band/channel WUR is operational, which can be different from the band/channel used for data transmission using the main receiver, e.g. WUR in 2.4 GHz band but data communication in 5 GHz band). It is also noted that the WUR operating channel is advertised in the beacon, and that the WUR discovery operating channel may be different from the WUR operating channel. Stations can then request to be configured with WUR mode of operation. This request has to be granted by the AP, and in case it is granted, the station is further configured/setup for WUR mode of operation (the configuration is only valid for the connection to the associated AP, and further the configuration must be torn down/de-configured if WUR is not to be used anymore). Both continuous WUR (receiver open all the time) and duty-cycled WUR (receiver only open during preconfigured time slots) mode of operations are supported. For the latter the length of the duty-cycles and on-time during wake up is part of the WUR configuration.

Unlike the 3GPP solution, the WUR operation mode is a “sub-state” of the regular operation and upon the detection of a WUS transmission from the AP, the station will resume the power saving mechanism it was configured with before entering the WUR operation mode. That is, IEEE has specified a number of different power saving mechanisms. For example, if duty-cycled monitoring of the downlink has been configured for the station it will switch to that upon detection of the WUS (unlike the specified 3GPP mechanism which only covers paging and the UE will continue to monitor PDCCH if WUS is detected). In this way, the IEEE WUR functionality is more general and stills allows for the station to upon detection of WUS “monitor paging” by checking in the beacon from the AP for which stations there is data, or for the station to directly respond with an uplink transmission.

A station receiving the IEEE WUS must synchronize to the wireless medium prior to performing any transmissions, i.e. using sync info in the beacon from the AP (typically transmitted every 100 ms) or from the transmission to another station. Synchronization to the wireless medium refers to the following in IEEE 802.11; a station changing from sleep to awake in order to transmit must perform channel clear assessment until it receives one or more frames that allow it to correctly set the virtual carrier sensing. This is to prevent collisions with transmissions from hidden nodes. (Essentially the virtual carrier sensing tells a station to defer for a time period even if the wireless medium appears to be idle, and can be set by receiving frames that indicate the duration of an ongoing frame exchange). Note that in WiFi typically one beacon transmission is enough to sync for the station (i.e., no need to acquire several transmission due to poor coverage). Unlike operation in licensed bands, the station also has to apply carrier sensing, and also possibly re-acquire channel sensing parameters, before uplink transmission.

The physical WUS in IEEE contains complete frames which much be processed by the station. The drawback with this design is that is requires more processing and handling and processing in the station, i.e. compared to a simple WUR design which trigger one pre-defined activity in case WUS is detected. The benefit is that it contains more information and the solution is more general. The IEEE WUS contains information to indicate if the WUS is a WUR sync beacon, a WUR discovery beacon, or a regular WUS (intended to wake the station up). The WUS can also contain proprietary frames, which could for example, be used to directly turn actuators on/off. The transmission uses on/off keying (OOK) modulation, using Manchester coding, but is using multi-carrier OOK that can be generated by an Orthogonal Frequency Division Multiplexing (OFDM) transmitter (i.e., WUR can be enabled as a software upgrade in APs). The WUS is 4 MHz wide, but a whole 20 MHz channel is reserved. The WUS starts with a 20 MHz legacy preamble (to allows other stations to perform carrier sense) followed by 4 MHz Manchester coded OOK. Two data rates are supported: 62.5 kbps and 250 kbps. Link adaptation is up to the AP (each packet is self-contained and includes the data rate, i.e. in the WUR there are two possible sync words used to signal the data rate).

The WUS can contain the following information:
Station ID, or group ID (grouping of stations is supported)
Payload up to 22 bytes.
Short frames contain only basic info; which WUR frame type+addressing.
Ordinary frames contain control info, and in addition proprietary info.
WUR beacons contain BSS-ID, sync information, time counter.
Similar structure for WUS and WUR beacons (sync words indicate the data rate, the station can then detect the header, from this the station can tell if it is WUS or beacon, then check body).
WUR discovery frames contain mobility related information to allow for lower power scan.

Regarding mobility, both WUR sync beacons and WUR discovery beacons has been specified, which only requires the WUR to be used for reception, such that stations can stay in the WUR operation mode unless there is data transmission for the station. For example, stations only need to switch back to legacy Power Saving Mode (PSM) upon WUS detection (or when moving to a new AP). WUR sync beacons are used by stations to obtain rough synchronization (for data transmission the legacy beacon must still be acquired), and WUR discovery beacons are used to carry (legacy) mobility information to enable quick/low energy scanning (allowing stations, only using the WUR, to get information related to local and roaming scans for nearby APs, e.g. SSID and main radio operating channels, if the channel quality should deteriorate).

That is, in the WUR discovery beacon the AP can indicate one or more BSS (basic service set, and the BSS-ID has a one-to-one mapping with the assigned Service Set Identifier(SSID) name) in which WUR is supported such that stations do not have to scan all frequencies/channels. Since the WUR discovery beacon contains the legacy mobility information, which means there is some duplication/redundancy in the broadcasted information. This allows for low power scanning, using only the WUR. Note however that mobility in IEEE is restricted to the same AP, and that hand-over between APs is not supported in the same way as in 3GPP. If a station in WUR operation mode moves to a new AP, it would have to move out of WUR operation mode and use the main receiver to obtain the beacon, sync, configuration, and associate to the new AP.

There currently exist certain challenge(s), however. For example, Low Power-Wake-up Signal (LP-WUS)/Low Power-WUR (LP-WUR) feature is being studied both for RRC_IDLE/INACTIVE and RRC_CONNECTED in Rel-18. For a solution with partial LP-WUS coverage in the cell (i.e., LP-WUS link performance is worse than the limiting legacy PHY-channel), UE mobility in RRC_CONNECTED may lead to that the UE becomes unreachable by the network in the downlink. That is, a UE configured with WUR operation moves out of LP-WUS coverage while still only monitoring the downlink using WUR.

### SUMMARY

Certain aspects of the disclosure and their embodiments may provide solutions to these or other challenges. For example, methods and systems are provided to be performed by a UE, or by a network node, when configured with WUR in RRC_CONNECTED to ensure that the UE if moving out of LP-WUS coverage does not become unreachable in the downlink.

According to certain embodiments, a method by a UE includes, while the UE is in a RRC connected state and is configured for WUR, performing at least one UE mobility measurement. Based on the at least one UE mobility measurement, the UE determines whether to perform WUR monitoring for a downlink channel.

According to certain embodiments, a UE in a RRC connected state and being configured for WUR, is configured to perform at least one UE mobility measurement. Based on the at least one UE mobility measurement, the UE is configured to determine whether to perform WUR monitoring for a downlink channel.

According to certain embodiments, a method by a network node includes receiving, from a UE, that is in a RC, connected state and is configured for WUR, at least one UE mobility measurement. Based on a comparison of a value associated with the at least one UE mobility measurement to a threshold, the network node determines whether to activate or deactivate WUR monitoring by the UE for a downlink channel. The network node transmits, to the UE, an indication of whether to activate or deactivate WUR monitoring by the UE for the downlink channel.

According to certain embodiments, a network node is configured to receive, from a UE, that is in a RC, connected state and is configured for WUR, at least one UE mobility measurement. Based on a comparison of a value associated with the at least one UE mobility measurement to a threshold, the network node is configured to determine whether to activate or deactivate WUR monitoring by the UE for a downlink channel. The network node is configured to transmit, to the UE, an indication of whether to activate or deactivate WUR monitoring by the UE for the downlink channel.

Certain embodiments may provide one or more of the following technical advantage(s). For example, certain embodiments may provide a technical advantage of making the WUR solution with partial LP-WUS coverage in the cell feasible. As another example, certain embodiments may provide a technical advantage of ensuring WUR UEs in RRC_CONNECTED do not become unreachable by the network in the downlink.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a location of a WUS and the paging occasion to which it is associated;

FIG. 2 illustrates WUS for NB-IoT and LTE-M;

FIG. 3 illustrates the use of eDRX and DRX WUS gaps for NB-IoT and LTE-M;

FIG. 4 illustrates a connected WUR handover, according to certain embodiments;

FIG. 5 illustrates an example communication system, according to certain embodiments;

FIG. 6 illustrates an example UE, according to certain embodiments;

FIG. 7 illustrates an example network node, according to certain embodiments;

FIG. 8 illustrates a block diagram of a host, according to certain embodiments;

FIG. 9 illustrates a virtualization environment in which functions implemented by some embodiments may be virtualized, according to certain embodiments;

FIG. 10 illustrates a host communicating via a network node with a UE over a partially wireless connection, according to certain embodiments;

FIG. 11 illustrates an example method by a UE, according to certain embodiments;

FIG. 12 illustrate an example method by a network node, according to certain embodiments;

FIG. 13 illustrates another example method by a UE, according to certain embodiments; and

FIG. 14 illustrate another example method by a network node, according to certain embodiments.

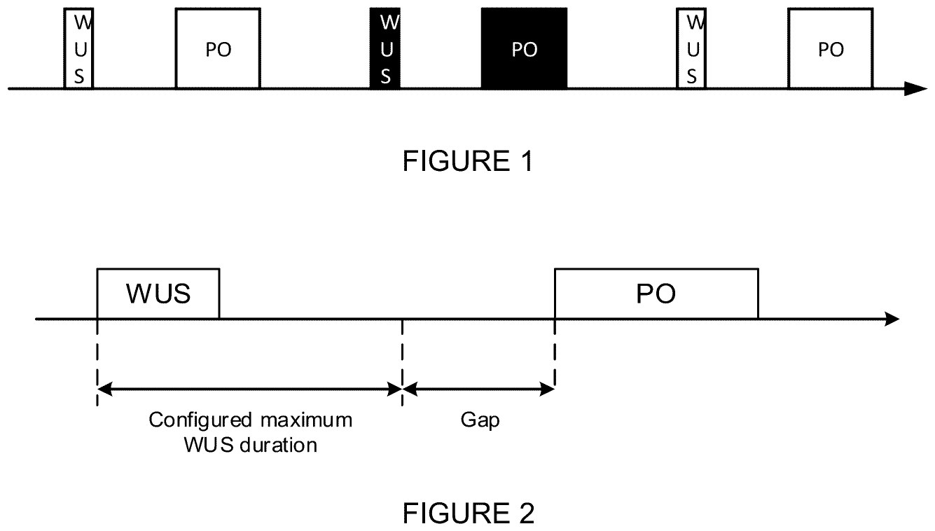

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, sPDSCH, sPUCCH, sPUSCH, MPDCCH, NPDCCH, NPDSCH, E-PDCCH, PUSCH, PUCCH, NPUSCH, etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, system frame number (SFN) cycle, hyper-SFN (H-SFN) cycle etc.

According to certain embodiments, methods and systems are provided to be performed by a UE, or by a network node, when configured with WUR in RRC_CONNECTED to ensure that the UE if moving out of LP-WUS coverage does not become unreachable in the downlink. The methods and systems may include one or more of:
RRC re-configuration and handover to WUR operation (WUR coverage area treated as a cell).
UE autonomous periodic measurement of LP-WUS coverage, and triggering of action if below a threshold.
Using main receiver infrequently as a safety precaution.
WUR UE mobility measurement reporting.

Herein, a UE in RRC_IDLE state is unknown to gNB and no connection is setup to the UE, nor does gNB keep any UE context for the UE. UE mobility in RRC_IDLE (and also in RRC_INACTIVE) is therefore a UE autonomous procedure, and the UE performs UE cell selection and cell re-selection without any signaling to gNB based on the cell (re-)selection criteria defined in 3GPP TS 38.304 and parameters and threshold defined in 3GPP TS 38.331 configured by gNB and signaled to the UE in system information broadcast.

In RRC_CONNECTED, the UE is known to gNB, a connection has been setup, gNB holds a UE context, and the UE has been UE-specifically configured. UE mobility in RRC_CONNECTED is under gNB control, that is, UE provides radio link quality or signal strength reporting (e.g., Reference Signal Received Power (RSRP), Reference Signal Received Quality (RSRQ), or Channel State Information (CSI) reports) to gNB, and gNB based on these reports initiates hand-over to another cell when needed via dedicated RRC signaling.

For a Connected WUR solution with partial LP-WUS coverage in the cell, gNB can therefore, based on existing or new radio link quality or signal strength reporting from the UE, determine if a (WUR capable) UE can be configured with WUR in Connected or not. When the UE moves in and out of LP-WUS coverage in the cell, gNB may reconfigure the UE to use WUR or not, accordingly. However, if the UE moves out of LP-WUS coverage before gNB can reconfigure the UE, the UE becomes unreachable in the downlink and gNB cannot signal to the UE (this since the UE still only monitors the downlink using WUR but the coverage of LP-WUS is too poor to reach the UE).

### WUR Handover

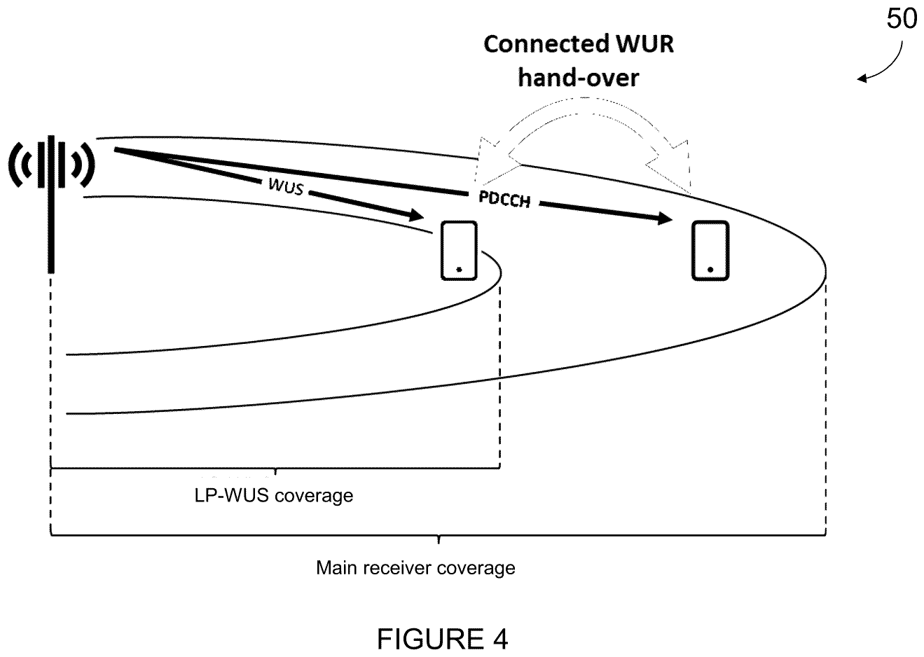

FIG. 4 illustrates a connected WUR handover 50, according to certain embodiments. In some embodiments, the LP-WUS coverage area is considered as a “separate cell” in the larger “parent” legacy cell. That is, based on the existing or new (i.e., WUR-specific) radio link quality or signal strength reporting, gNB could initiate hand-over via RRC signaling. For example, as part of gNB implementation, if the UE RSRP and/or RSRQ based on main receiver measurements is stronger than a certain threshold (possibly with the added conditions on being so for a duration of time, or for a number N UE reports), gNB initiates a hand-over from the legacy “parent” cell (source) to the WUR cell (target). Alternatively, the UE is configured to perform mobility measurements using WUR also outside LP-WUS coverage just for the sake of UE link quality reporting.

Reversely, if the UE RSRP and/or RSRQ based on WUR measurements is weaker than a certain threshold (possibly with the added conditions on being so for a duration of time, or for a number N UE reports), gNB initiates a hand-over from the WUR cell (source) to the legacy “parent” cell (target). Alternatively, the UE is configured to infrequently perform mobility measurements using the main receiver also inside LP-WUS coverage just for the sake of UE link quality reporting.

If there is no differentiation for RRC_IDLE or RRC_INACTIVE, physical cell ID (PCID) could be kept the same the legacy “parent” cell, that is, the WUR cell is not considered as a separate cell for Idle/Inactive mode cell selection and cell re-selection. However, if WUR is also used in RRC_IDLE or RRC_INACTIVE, or if it is found to be beneficial for Connected WUR operation, a separate PCID may be configured for Connected WUR (e.g., signaled in the low-power sync-signal, LP-SS, or signaling as part of the LP-WUS to differentiate from LP-WUS transmissions in adjacent cells).

The specification impact for this embodiment is potentially new UE mobility measurement reporting configuration such as, for example, CSI reports performed using the WUR, and enhanced signaling for the hand-over commands to or from a “WUR cell”.

For the UE mobility measurement reporting, reporting of a WUR cell could be supported in as a new MeasurementReport message, for example as follows:

MeasurementReportWur message

-- ASN1START
-- TAG-MEASUREMENTREPORTWUR-START

| | |
|---|---|
| MeasurementReportWur ::= | SEQUENCE { |
| criticalExtensions | CHOICE { |
| measurementReportWur-r19 | MeasurementReportWur-r19-IEs, |
| criticalExtensionsFuture | SEQUENCE { } |

}
}

| | |
|---|---|
| MeasurementReportWur-r19-IEs ::= | SEQUENCE { |
| wur-measResults-r19 | WUR-MeasResults-r19, |
| lateNonCriticalExtension | OCTET STRING |

OPTIONAL,

| | |
|---|---|
| nonCriticalExtension | SEQUENCE{ } |

OPTIONAL
}

| | |
|---|---|
| WUR-MeasResults-r19 ::= | SEQUENCE { |
| wur-MeasId-r19 | WUR-MeasId-r19, |
| wur-MeasResult-r19 | WUR-MeasResult-r19, |

...
}

| | |
|---|---|
| WUR-MeasResult-r19 ::= | SEQUENCE { |
| wur-ResultWUS-r19 | WUR-MeasQuantityResult-r19 |

OPTIONAL,
...
}

| | |
|---|---|
| WUR-MeasQuantityResult-r19 ::= | SEQUENCE { |
| wur-RSRP-r19 | RSRP-Range |

OPTIONAL,
...
}
-- TAG-MEASUREMENTREPORTWUR-STOP
-- ASN1STOP

Alternatively, it could be supported as extension of MeasResults, reusing the existing MeasurementReport message. E.g., as follows (addition in underlined italics):

MeasResults information element

-- ASN1START
-- TAG-MEASRESULTS-START

| | |
|---|---|
| MeasResults ::= | SEQUENCE { |
| measId | MeasId, |

| | |
|---|---|
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16, |
| sl-MeasResultsCandRelay-r17 | OCTET STRING -- Contains PC5 SL- |

| | |
|---|---|
| MeasResultListRelay-r17 | OPTIONAL, |

```
  }
  ...,
  [[
```

| | |
|---|---|
| measResultServFreqListEUTRA-SCG | MeasResultServFreqListEUTRA-SCG |

OPTIONAL,

| | |
|---|---|
| measResultServFreqListNR-SCG | MeasResultServFreqListNR-SCG |

OPTIONAL,

| | |
|---|---|
| measResultSFTD-EUTRA | MeasResultSFTD-EUTRA |

OPTIONAL,

| | |
|---|---|
| measResultSFTD-NR | MeasResultCellSFTD-NR |

```
OPTIONAL
  ]],
  [[
```

| | |
|---|---|
| measResultCellListSFTD-NR | MeasResultCellListSFTD-NR |

```
OPTIONAL
  ]],
  [[
```

| | |
|---|---|
| measResultForRSSI-r16 | MeasResultForRSSI-r16 |

OPTIONAL,

| | |
|---|---|
| locationInfo-r16 | LocationInfo-r16 |

OPTIONAL,

| | |
|---|---|
| ul-PDCP-DelayValueResultList-r16 | UL-PDCP-DelayValueResultList-r16 |

OPTIONAL,

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
  ]],
  [[
```

| | |
|---|---|
| measResultRxTxTimeDiff-r17 | MeasResultRxTxTimeDiff-r17 |

OPTIONAL,

| | |
|---|---|
| sl-MeasResultServingRelay-r17 | OCTET STRING |

OPTIONAL,

| | |
|---|---|
| r17 | -- Contains PC5 SL-MeasResultRelay- |

| | |
|---|---|
| ul-PDCP-ExcessDelayResultList-r17 | UL-PDCP-ExcessDelayResultList-r17 |

OPTIONAL,

| | |
|---|---|
| coarseLocationInfo-r17 | OCTET STRING |

```
OPTIONAL
  ]],
  [[
  measResultWUR-r19 MeasResultWUR-r19
OPTIONAL
  ]]
}
```

| | |
|---|---|
| MeasResultServMOList ::= | SEQUENCE (SIZE (1..maxNrofServingCells)) OF |

MeasResultServMO

| | |
|---|---|
| MeasResultServMO ::= | SEQUENCE { |

| | |
|---|---|
| servCellId | ServCellIndex, |

| | |
|---|---|
| measResultServingCell | MeasResultNR, |
| measResultBestNeighCell | MeasResultNR |

OPTIONAL,
...
}
:
<text omitted>
:
UL-PDCP-DelayValueResult-r16 ::= SEQUENCE {

| | |
|---|---|
| drb-Id-r16 | DRB-Identity, |
| averageDelay-r16 | INTEGER (0..10000), |

...
}
UL-PDCP-ExcessDelayResultList-r17 ::= SEQUENCE (SIZE (1..maxDRB)) OF UL-PDCP-
ExcessDelayResult-r17
UL-PDCP-ExcessDelayResult-r17 ::= SEQUENCE {

| | |
|---|---|
| drb-Id-r17 | DRB-Identity, |
| excessDelay-r17 | INTEGER (0..31), |

```
  ...
}
TimeBetweenEvent-r17 ::= INTEGER (0..1023)
MeasResultWUR-r19 ::= SEQUENCE {
  physCellId-r19 PhysCellIdWUR-r19,
  measResult MeasResultsWUR,
}
MeasResultsWUR ::= SEQUENCE {
  rsrp RSRP-RangeWUR
OPTIONAL,
  rsrq RSRO-RangeWUR OPTIONAL
}
-- TAG-MEASRESULTS-STOP
-- ASN1STOP
```

According to certain embodiments, measurement reporting could be expanded to also cover WUR reporting (addition in underlined italics):

### 5.5 Measurements

### 5.5.1 Introduction

The network may configure an RRC_CONNECTED UE to perform measurements. The network may configure the UE to report them in accordance with the measurement configuration or perform conditional reconfiguration evaluation in accordance with the conditional reconfiguration. The measurement configuration is provided by means of dedicated signalling i.e. using the RRCReconfiguration or RRCResume.

The network may configure the UE to perform the following types of measurements:
NR measurements;
Inter-RAT measurements of E-UTRA frequencies;
Inter-RAT measurements of UTRA-FDD frequencies;
NR sidelink measurements of L2 U2N Relay UEs.

The network may configure the UE to report the following measurement information based on SS/PBCH block(s):
Measurement results per SS/PBCH block;
Measurement results per cell based on SS/PBCH block(s);
SS/PBCH block(s) indexes.

The network may configure the UE to report the following measurement information based on CSI-RS resources:
Measurement results per CSI-RS resource;
Measurement results per cell based on CSI-RS resource(s);
CSI-RS resource measurement identifiers.

The network may configure the UE to perform the following types of measurements for NR sidelink and V2X sidelink:
CBR measurements.

The network may configure the UE to report the following CLI measurement information based on SRS resources:
Measurement results per SRS resource;
SRS resource(s) indexes.

The network may configure the UE to report the following CLI measurement information based on CLI-RSSI resources:
Measurement results per CLI-RSSI resource;
CLI-RSSI resource(s) indexes.

The network may configure the UE to report the following Rx-Tx time difference measurement information based on CSI-RS for tracking or PRS:
UE Rx-Tx time difference measurement result.

The network may configure the UE to perform the following types of measurements for WUR:
LP-WUS measurements.

Further, new UE mobility measurement report triggering conditions, and associated thresholds, could be introduced for WUR (corresponding to those in Section 5.5.4 of TS 38.331). For example, WUR-specific alternatives of trigger event A2, ‘Event A2 (Serving becomes worse than threshold)’, and trigger event A4, ‘Event A4 (Neighbour becomes better than threshold)’, could be defined. A2 to keep track of when the WUR serving cell is becoming too weak such that there is time to re-configure the UE before LP-WUS coverage is lost. A4 to keep track of when the neighbor WUR cell (i.e., the child WUR cell inside the parent legacy cell) becomes strong enough such that WUR can be configured for the UE.

In one implementation, the UE mobility reporting for this purpose is limited to the WUR cell and its parent cell (supporting only “intra-cell mobility”). To reduce signaling, reporting of relative signal strength could be supported in this case, i.e., the UE instead of reporting the signal strength of both the WUR cell and the legacy parent cell, it only report to WUR cell strength relative to the legacy parent cell (i.e., quantized levels of stronger or weaker than). In another signaling reduction solution, the UE only reports the WUR cell signal strength if it is below a configured threshold (similar to event A2 above). This avoids unnecessary signaling when the WUR cell is strong enough, but could indicate when the WUR cell signal strength is dropping to gNB and provide an opportunity to reconfigure the UE before it moves out of LP-WUS coverage.

In another implementation, also the UE can be configured to report also the WUR cell signal strength of neighbor WUR cells. This would enable hand-over from one WUR cell to another WUR cell.

Regarding the HO signaling, in the simplest case in which HO between WUR cells belonging to different gNBs is not supported, the HO would only be gNB internal and only signaling between the UE and gNB is required (i.e., no target gNB to source gNB signaling required). In this case, some WUR-specific additions to the RRCReconfiguration message from gNB to UE would be required to be able to indicate to the UE if it is being handed over to or from a WUR cell. In one embodiment, a new PCID is assigned to the WUR cell and this PhysCellId is indicated to the UE in the ServingCellConfigCommon IE of the RRCReconfiguration (handover corresponds to RRCReconfiguration with IE ReconfigurationWithSync included). In another embodiment, where the WUR cell instead reuses the PCID of the legacy parent cell, it must be indicated in the RRCReconfiguration message that the UE is being re-configured, still with the same serving cell, but now with WUR configured. This could be done as an extension, for example as follows (addition in underlined italics):

RRCReconfiguration message

-- ASN1START
-- TAG-RRCRECONFIGURATION-START

| | |
|---|---|
| RRCReconfiguration ::= | SEQUENCE { |
| rrc-TransactionIdentifier | RRC- |

TransactionIdentifier,

| | |
|---|---|
| criticalExtensions | CHOICE { |

rrcReconfiguration
RRCReconfiguration-IEs,

| | |
|---|---|
| criticalExtensionsFuture | SEQUENCE { } |

}
}

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING |

(CONTAINING CellGroupConfig)
OPTIONAL, -- Cond SCG

| | |
|---|---|
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration- |
| v1530-IEs | OPTIONAL |

}

| | |
|---|---|
| RRCReconfiguration-v1530-IEs ::= | SEQUENCE { |
| masterCellGroup | OCTET STRING |

(CONTAINING CellGroupConfig)
OPTIONAL, -- Need M

| | |
|---|---|
| fullConfig | ENUMERATED {true} |

OPTIONAL, -- Cond FullConfig

| | |
|---|---|
| dedicatedNAS-MessageList | SEQUENCE |

(SIZE(1..maxDRB)) OF DedicatedNAS-Message
OPTIONAL, -- Cond nonHO

| | |
|---|---|
| masterKeyUpdate | MasterKeyUpdate |

OPTIONAL, -- Cond MasterKeyChange

| | |
|---|---|
| dedicatedSIB1-Delivery | OCTET STRING |

(CONTAINING SIB1)
OPTIONAL, -- Need N

| | |
|---|---|
| dedicatedSystemInformationDelivery | OCTET STRING |

(CONTAINING SystemInformation)
OPTIONAL, -- Need N

| | |
|---|---|
| otherConfig | OtherConfig |

OPTIONAL, -- Need M

| | |
|---|---|
| nonCriticalExtension | RRCReconfiguration- |
| v1540-IEs | OPTIONAL |

}

| | |
|---|---|
| RRCReconfiguration-v1540-IEs ::= | SEQUENCE { |
| otherConfig-v1540 | OtherConfig-v1540 |

OPTIONAL, -- Need M

| | |
|---|---|
| nonCriticalExtension | RRCReconfiguration- |
| v1560-IEs | OPTIONAL |

}

| | |
|---|---|
| RRCReconfiguration-v1560-IEs ::= | SEQUENCE { |
| mrdc-SecondaryCellGroupConfig | SetupRelease { |
| MRDC-SecondaryCellGroupConfig } | OPTIONAL, |

-- Need M

| | |
|---|---|
| radioBearerConfig2 | OCTET STRING |

(CONTAINING RadioBearerConfig)
OPTIONAL, -- Need M

| | |
|---|---|
| sk-Counter | SK-Counter |

OPTIONAL, -- Need N

| | |
|---|---|
| nonCriticalExtension | RRCReconfiguration- |
| v1610-IEs | OPTIONAL |

}

| | |
|---|---|
| RRCReconfiguation-v1610-IEs ::= | SEQUENCE { |
| otherConfig-v1610 | OtherConfig-v1610 |

OPTIONAL, -- Need M

| | |
|---|---|
| bap-Config-r16 | SetupRelease { BAP- |
| Config-r16 } | OPTIONAL, -- |

Need M

| | |
|---|---|
| iab-IP-AddressConfigurationList-r16 | IAB-IP- |

AddressConfigurationList-r16
OPTIONAL, -- Need M
conditionalReconfiguation-r16
ConditionalReconfiguation-r16
OPTIONAL, -- Need M

| | |
|---|---|
| daps-SourceRelease-r16 | ENUMERATED{true} |

OPTIONAL, -- Need N

| | |
|---|---|
| t316-r16 | SetupRelease {T316- |
| r16} | OPTIONAL, -- |

Need M

| | |
|---|---|
| needForGapsConfigNR-r16 | SetupRelease |

{NeedForGapsConfigNR-r16}
OPTIONAL, -- Need M

| | |
|---|---|
| onDemandSIB-Request-r16 | SetupRelease { |
| OnDemandSIB-Request-r16 } | OPTIONAL, |

-- Need M

| | |
|---|---|
| dedicatedPosSysInfoDelivery-r16 | OCTET STRING |

(CONTAINING PosSystemInformation-r16-IEs)
OPTIONAL, -- Need N

| | |
|---|---|
| sl-ConfigDedicatedNR-r16 | SetupRelease {SL- |
| ConfigDedicatedNR-r16} | OPTIONAL, -- |

Need M

| | |
|---|---|
| sl-ConfigDedicatedEUTRA-Info-r16 | SetupRelease {SL- |
| ConfigDedicatedEUTRA-Info-r16} | OPTIONAL, -- |

Need M

| | |
|---|---|
| targetCellSMTC-SCG-r16 | SSB-MTC |

OPTIONAL, -- Need S

| | |
|---|---|
| nonCriticalExtension | RRCReconfiguration- |
| v1700-IEs | OPTIONAL |

}

| | |
|---|---|
| RRCReconfiguration-v1700-IEs ::= | SEQUENCE { |
| otherConfig-v1700 | OtherConfig-v1700 |

OPTIONAL, -- Need M

| | |
|---|---|
| sl-L2RelayUE-Config-r17 | SetupRelease { SL- |
| L2RelayUE-Config-r17 } | OPTIONAL, -- Need M |
| sl-L2RemoteUE-Config-r17 | SetupRelease { SL- |
| L2RemoteUE-Config-r17 } | OPTIONAL, -- Need M |
| dedicatedPagingDelivery-r17 | OCTET STRING |
| (CONTAINING Paging) | OPTIONAL, -- |

Cond PagingRelay

| | |
|---|---|
| needForGapNCSG-ConfigNR-r17 | SetupRelease |
| {NeedForGapNCSG-ConfigNR-r17} | OPTIONAL, -- |

Need M

| | |
|---|---|
| needForGapNCSG-ConfigEUTRA-r17 | SetupRelease |
| {NeedForGapNCSG-ConfigEUTRA-r17} | OPTIONAL, -- |

Need M

| | |
|---|---|
| musim-GapConfig-r17 | SetupRelease {MUSIM- |
| GapConfig-r17} | OPTIONAL, -- Need M |
| ul-GapFR2-Config-r17 | SetupRelease { UL- |
| GapFR2-Config-r17 } | OPTIONAL, -- Need M |
| scg-State-r17 | ENUMERATED { |
| deactivated } | OPTIONAL, -- |

Need N

| | |
|---|---|
| appLayerMeasConfig-r17 | AppLayerMeasConfig- |
| r17 | OPTIONAL, -- Need M |
| ue-TxTEG-RequestUL-TDOA-Config-r17 | SetupRelease {UE- |
| TxTEG-RequestUL-TDOA-Config-r17} | OPTIONAL, -- Need |

M

| | |
|---|---|
| nonCriticalExtension | RRCReconfiguration- |

```
v1900-IEs OPTIONAL
}
RRCReconfiguration-v1900-IEs ::= SEQUENCE {
  wur-Config-r19 SetupRelease { WUR-
Config-r19 } OPTIONAL, -- Need M
  nonCriticalExtension SEQUENCE
{ } OPTIONAL
}
```

For WUR handover between WUR cells, WUR configuration could be appended to the RRC HO preparation message to allow the UE to continue WUR monitoring in the target cell. E.g., with the following extension (addition in underlined italics):

HandoverPreparationInformation message

-- ASN1START
-- TAG-HANDOVER-PREPARATION-INFORMATION-START

| | |
|---|---|
| HandoverPreparationInformation ::= | SEQUENCE { |
| criticalExtensions | CHOICE { |
| c1 | CHOICE{ |

```
      handoverPreparationInformation
HandoverPreparationInformation-IEs,
      spare3 NULL, spare2 NULL, spare1 NULL
    } ,
```

| | |
|---|---|
| criticalExtensionsFuture | SEQUENCE { } |

}
}
HandoverPreparationInformation-IEs ::= SEQUENCE {

| | |
|---|---|
| ue-CapabilityRAT-List | UE-CapabilityRAT- |

ContainerList,

| | |
|---|---|
| sourceConfig | AS-Config |

OPTIONAL, -- Cond HO

| | |
|---|---|
| rrm-Config | RRM-Config |

OPTIONAL,

| | |
|---|---|
| as-Context | AS-Context |

OPTIONAL,

| | |
|---|---|
| nonCriticalExtension | SEQUENCE { } |

OPTIONAL
}

| | |
|---|---|
| AS-Config ::= | SEQUENCE { |
| rrcReconfiguration | OCTET STRING |

```
(CONTAINING RRCReconfiguration) ,
  ...
  [[
```

| | |
|---|---|
| sourceRB-SN-Config | OCTET STRING |
| (CONTAINING RadioBearerConfig) | OPTIONAL, |
| sourceSCG-NR-Config | OCTET STRING |
| (CONTAINING RRCReconfiguration) | OPTIONAL, |
| sourceSCG-EUTRA-Config | OCTET STRING |

```
OPTIONAL
  ]],
  [[
```

| | |
|---|---|
| sourceSCG-Configured | ENUMERATED {true} |

```
OPTIONAL
  ]],
  [[
```

| | |
|---|---|
| sdt-Config-r17 | SDT-Config-r17 |

```
OPTIONAL
  ]],
  [[
  wur-Config-r19 WUR-Config-r19
OPTIONAL
  ]]
}
:
:
```

### Periodic UE Evaluation

According to certain embodiments, the UE periodically checks autonomously if it is out of LP-WUS coverage, either using WUR or MR, and thresholds configured accordingly. That is, if the UE is configured with Connected WUR and moves out of LP-WUS coverage before gNB has the possibility to de-configure WUR for the UE, the UE would in the next periodic measurement occasion notice that it has moved out of LP-WUS coverage and would take action.

The UE measurement would be using the WUR to measure the signal strength of LP-WUS, and comparing this measurement to a configured threshold, e.g., a WUR-specific RSRP-threshold. (Alternatively, measurements could be performed by the main receiver and a threshold configured for these measurements which would correspond to the LP-WUS coverage. But WUR gain will be reduced by having to start to main receiver typically). The WUR-specific RSRP-threshold would be configured (as part of the UE-specific WUR configuration) to correspond to the limit of LP-WUS coverage in the cell. If the UE measurement is below the configured threshold the UE would take action, e.g. RSRPₘₑₐₛ<RSRP_{threshold}.

The triggered action could be any of the following:
Connected WUR is implicitly de-configured/released in the UE, and UE start monitoring the downlink according to legacy/non-WUR procedure (e.g., using Connected mode short or long DRX).
   gNB could be notified about the UE state change in by:
      UE indication in subsequent response (new control indication, e.g. RRC indication or MAC CE). The UE would be reachable since it is now monitoring PDCCH, and gNB upon attempting to reach the UE is transmitting WUS+PDCCH (similar to Rel-16, LP-WUS is transmitted before the on during and then PDCCH in the on-duration). gNB will not be able to determine that LP-WUS was not received by the UE, therefore the above indication is needed.
      No response from the UE, in case only LP-WUS is transmitted or different PDCCH search space is used with and without WUR configured. After a time of no response from the UE, which is known to still be located in the cell, the gNB would fallback and attempt to reach the UE by legacy/non-WUR procedure (up to network implementation). (This case is less plausible legacy PDCCH signaling would always be needed when scheduling the UE, and it is known to gNB that the UE is still in the cell).
   The UE initiated an access attempt and random access procedure to indicate to gNB that it has moved out of LP-WUS coverage.
      gNB would explicitly be informed about the UE state change.

The configuration of how often the UE would perform these measurements to ensure it is still in LP-WUS coverage, and also the thresholds to be used, would be UE-specifically configured for the UE as part of the Connected WUR configuration.

### Periodic Reception Using MR

According to certain other embodiments, the main receiver can used with longer DRX cycle (or more infrequent search space) as a safety precaution. That is, the WUR gains in terms of reduced UE energy consumption mainly comes from keeping the main receiver in a sleep state, so using the main receiver frequently will reduce the WUR gain. However, the main receiver could infrequently be started to monitor the downlink, in case the UE has moved out of LP-WUS coverage it will then still be reachable (PDCCH) in these occasions. One way to achieve this is to pair the WUR configuration with, for example, a Long C-DRX configuration of the main receiver. For example, if the WUR is either monitoring continuously or with a 4 ms DRX cycle, a long C-DRX of 1280 ms could be configured for the main receiver. Both UE and gNB would have a common understanding of the configuration, and should the gNB fail to reach the UE with the WUR configuration (e.g. due to the UE being out of LP-WUS coverage) reaching the UE in the long C-DRX occasion using legacy procedure would still be successful. In another configuration alternative the main receiver is used in a subset of the LP-WUS monitoring occasions, e.g. in every N^{th} monitoring occasion, where N is configurable.

In an add-on to this, legacy mobility measurements using the main receiver (e.g. CSI-reporting) could be linked to this secondary C-DRX configuration for the main receiver whenever WUR is configured. The rationale being that if the main receiver is anyway started for this non-WUR fallback monitoring, main receiver measurements could just as well be carried out at the same time.

### UE LP-WUS Measurement Reporting

To support the above embodiments, UE mobility measurements using WUR are introduced. Radio link quality or signal strength may be measured by the UE and reported to gNB (e.g., LP-WUS RSRP, RSRQ, CSI, etc.). Such reporting may be the basis for gNB to determine if Connected WUR could be configured for the UE or not.

In an alternative embodiment, the main receiver may, instead, be used and e.g. legacy measurement reports may be compared to a threshold corresponding to LP-WUS coverage. That is, main receiver mobility measurement reporting could be mapped to WUR LP-WUS mobility measurement reporting. This, however, requires that gNB is aware of which type of WUR the UE equipped with. In one embodiment UE capability signaling indicates the class of WUR the UE is capable of (i.e. the sensitivity and capability of the WUR) and gNB may, after retrieving this information (legacy UE capability reporting and fetching those from AMF, determine the mapping of main receiver to WUR mobility measurements.

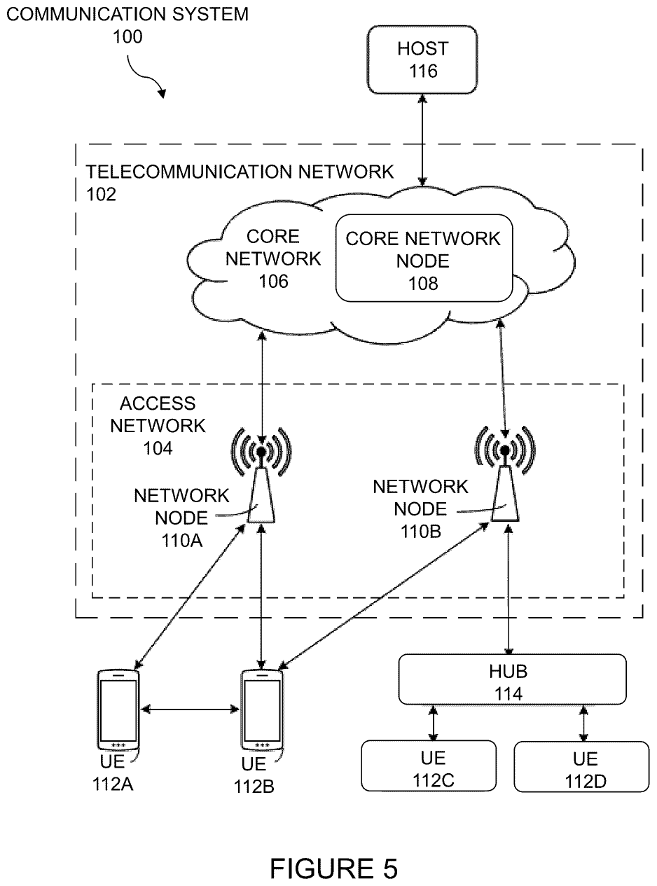

FIG. 5 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

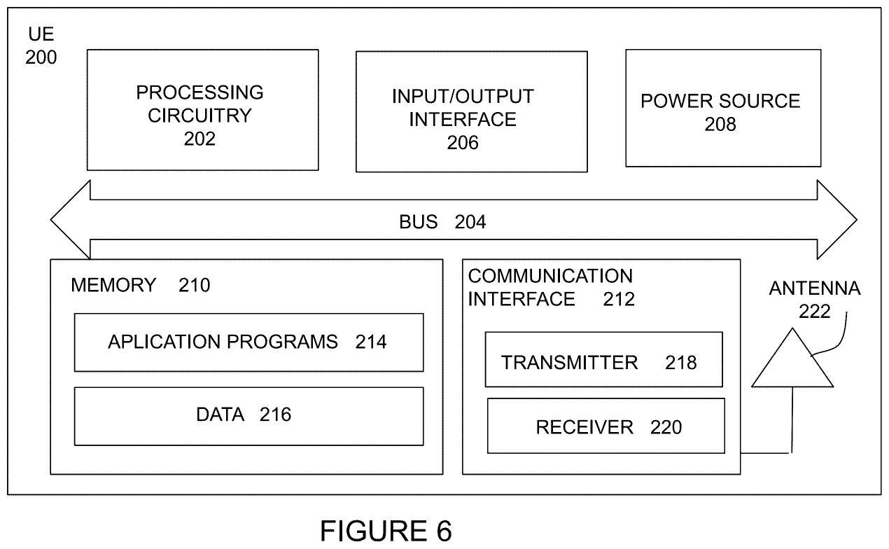

FIG. 6 shows a UE 200, which may be an embodiment of the UE 112 of FIG. 5, in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

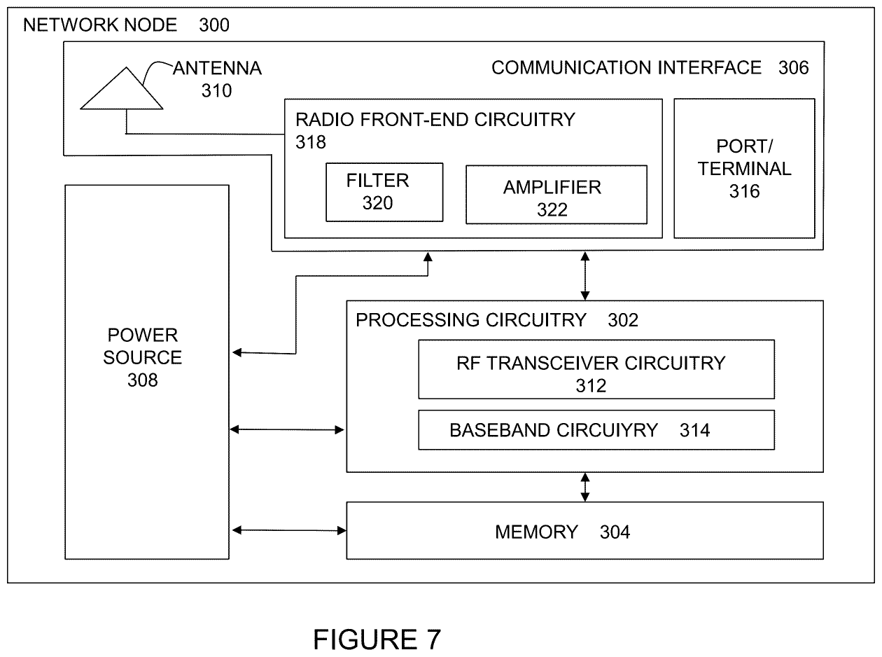

FIG. 7 shows a network node 300, which may be an embodiment of the network node 110 of FIG. 5, in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 7 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

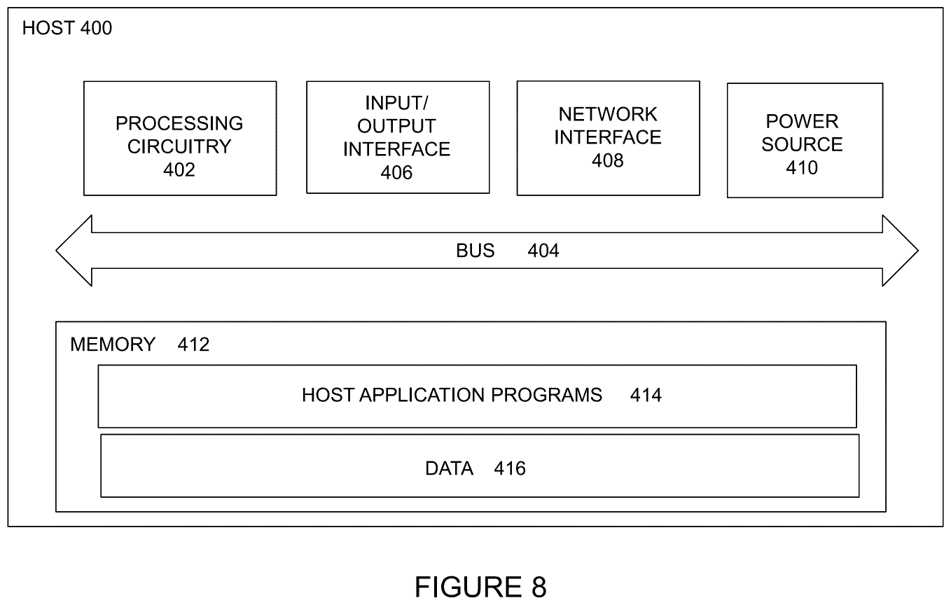

FIG. 8 is a block diagram of a host 400, which may be an embodiment of the host 116 of FIG. 5, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

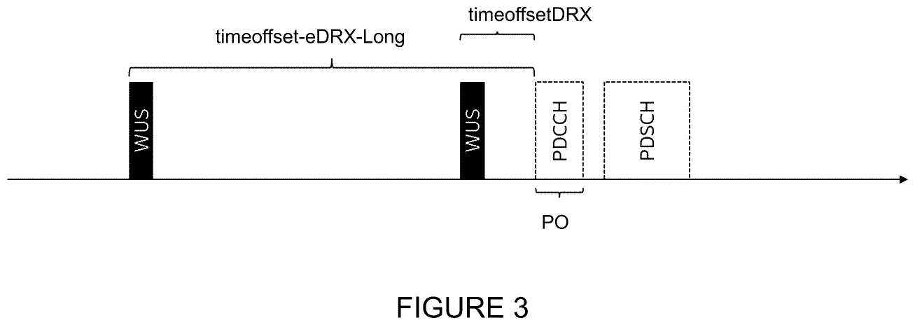

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

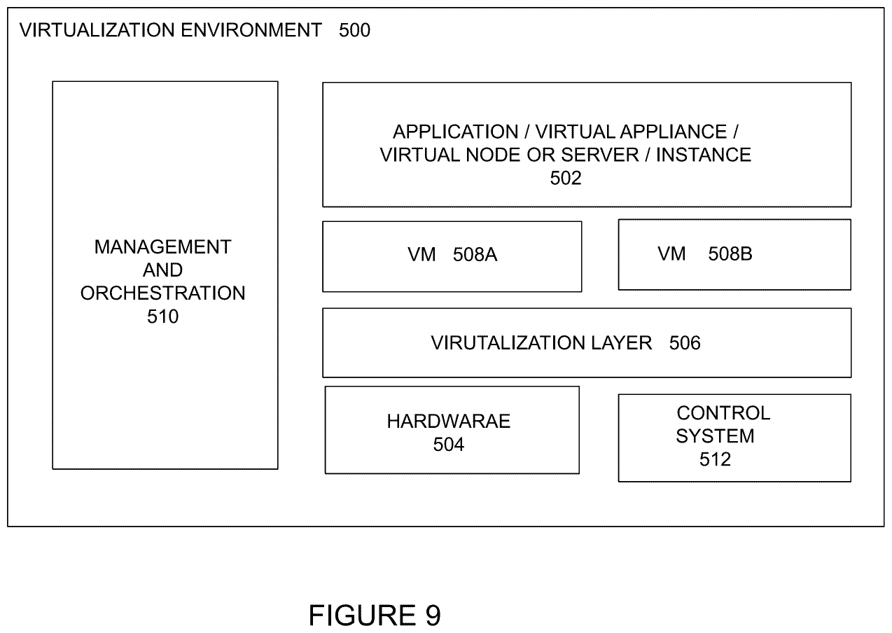

FIG. 9 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

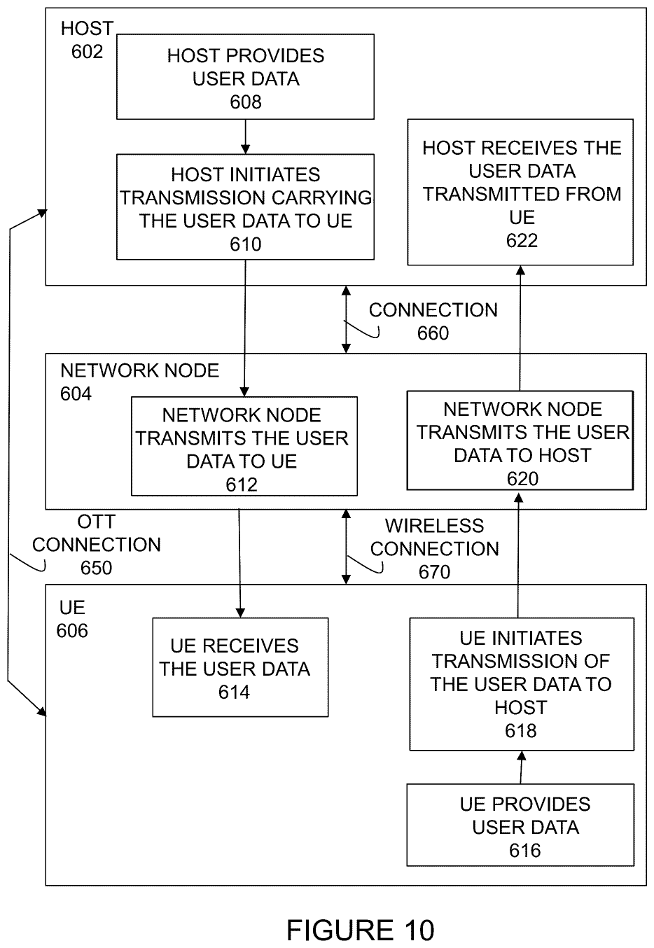

FIG. 10 shows a communication diagram of a host 602 communicating via a network node 604 with a UE 606 over a partially wireless connection in accordance with some embodiments.

Example implementations, in accordance with various embodiments, of the UE (such as a UE 112a of FIG. 5 and/or UE 200 of FIG. 6), network node (such as network node 110a of FIG. 5 and/or network node 300 of FIG. 7), and host (such as host 116 of FIG. 5 and/or host 400 of FIG. 8) discussed in the preceding paragraphs will now be described with reference to FIG. 10.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 5) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

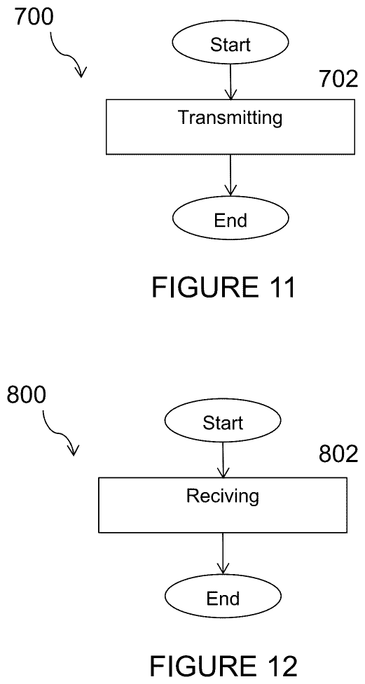

FIG. 11 illustrates an example method 700 by a UE, according to certain embodiments. In the illustrated embodiment, the method includes at least one transmitting step at 702. For example, at step 702, the UE may transmit, to a network node, at least one measurement associated with a Wake-Up Radio (WUR) cell. Additionally or alternatively, in the same or another transmitting step, the UE may transmit, to the network node, an indication that at least one WUR cell has been deconfigure and/or released.

FIG. 12 illustrates an example method 800 by a network node, according to certain embodiments. In the illustrated embodiment, the method includes at least one receiving step at 802. For example, at step 802, the network node may receive, from a UE, at least one measurement associated with a WUR cell. Additionally or alternatively, in the same or another receiving step, the network node may receive, from, the UE, an indication that at least one WUR cell has been deconfigure and/or released.

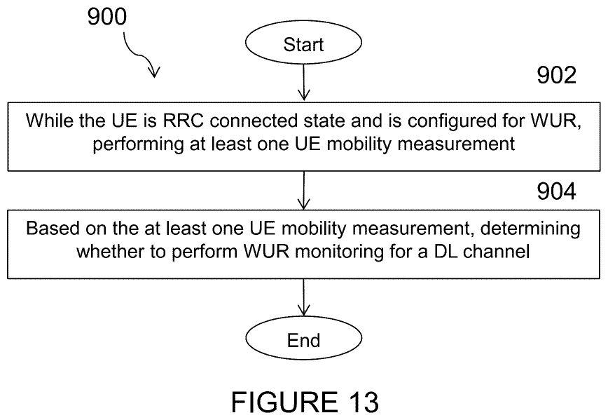

FIG. 13 illustrates an example method 900 performed by a UE, according to certain embodiments. As illustrated, the method begins at step 902 when, while the UE is in a RRC connected state and is configured for WUR, the UE performs at least one UE mobility measurement. Based on the at least one UE mobility measurement, the UE determines whether to perform WUR monitoring for a downlink channel, at step 904.

In a particular embodiment, determining whether to perform WUR monitoring for the downlink channel includes comparing at least one value associated with the at least one UE mobility measurement to a threshold. When the at least one value associated with the at least one UE mobility measurement is above the threshold, the UE determines to perform WUR monitoring for the downlink channel.

In a further particular embodiment, the UE monitors the downlink channel using WUR monitoring.

In a particular embodiment, determining whether to perform WUR monitoring for the downlink channel includes comparing at least one value associated with the at least one UE mobility measurement to a threshold. When the at least one value associated with the at least one UE mobility measurement is below the threshold, the UE determines not to perform WUR monitoring for the downlink channel.

In a further particular embodiment, the UE monitors the downlink channel using non-WUR monitoring.

In a particular embodiment, the UE receives, from a network node 110, configuration information configuring the UE to autonomously determine whether or not to perform WUR monitoring for the downlink channel.

In a particular embodiment, determining whether to perform WUR monitoring for the downlink channel includes transmitting to the network node, the at least one value associated with the at least one UE mobility measurement and receiving, from the network node, an indication to monitor the downlink channel using WUR monitoring or non-WUR monitoring.

In a further particular embodiment, the at least one UE mobility measurement is transmitted to the network node in a measurement report.

In a particular embodiment, determining whether to perform WUR monitoring for the downlink channel includes transmitting to the network node, the at least one value associated with the at least one UE mobility measurement, and receiving, from the network node, a signal to initiate a handover to or from the WUR cell.

In a further particular embodiment, the at least one signal to initiate the handover comprises a handover command to initiate the handover of the UE from a source cell to a target cell. At least one of the source cell and the target cell are a WUR cell.

In a further particular embodiment, the target cell comprises a primary serving cell and/or a parent of a WUR cell.

In a particular embodiment, the at least one measurement comprises at least one of: at least one value associated with a low power-wake up signal, LP-WUS, measurement; at least one value associated with at least one Reference Signal Received Power measurement; at least one value associated with at least one Reference Signal Received Quality measurement; at least one value associated with at least one Channel State Information measurement; at least one value associated with at least one Signal Interference to Noise Ratio measurement; and/or at least one value associated with at least one Signal Noise Ratio measurement.

In a particular embodiment, the UE receives, from the network node, measurement configuration information. The at least one measurement is based on the measurement configuration information.

In a particular embodiment, the UE receives, from the network node, a measurement reporting configuration comprising at least one WUR reporting criteria and determines that the at least one WUR reporting criteria is met. The at least one measurement is transmitted to the network node based on the at least one reporting criteria being met.

In a particular embodiment, the at least one WUR reporting criteria comprises at least one of: a value associated with the at least one measurement is greater than at least one first threshold; a value associated with the at least one measurement is less than at least one second threshold; a number of values associated with the at least one measurement are greater than at least one third threshold; a number of values associated with the at least one measurement are less than at least one fourth threshold; a value or a number of values associated with the at least one measurement are greater than at least one fifth threshold for an amount of time that is equal to or more than a minimum duration of time; and a value or a number of values associated with the at least one measurement are less than at least one sixth threshold for an amount of time that is equal to or more than a minimum duration of time.

In a particular embodiment, the UE transmits, to the network node, information indicating a capability of the UE to perform WUR monitoring.

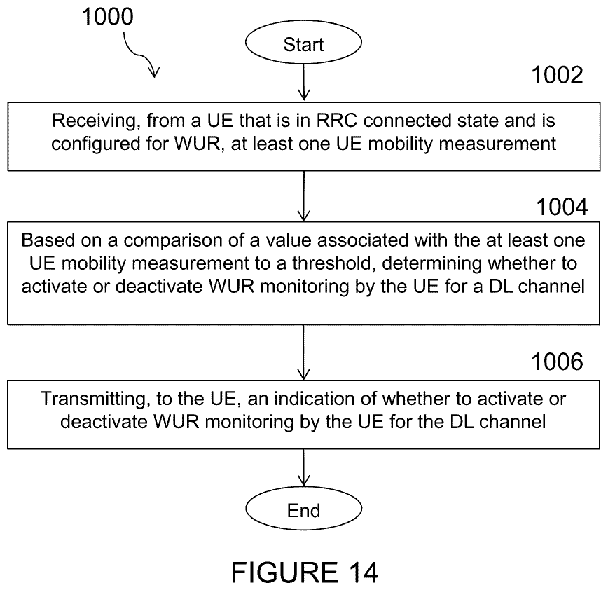

FIG. 14 illustrates an example method 1000 performed by a network node, according to certain embodiments. As illustrated, the method begins at step 1002 when the network node 112 receives, from a UE, that is in a RRC connected state and is configured for WUR, at least one UE mobility measurement. Based on a comparison of a value associated with the at least one UE mobility measurement to a threshold, the network node determines whether to activate or deactivate WUR monitoring by the UE for a downlink channel, at step 1004. At step 1006, the network node transmits, to the UE, an indication of whether to activate or deactivate WUR monitoring by the UE for the downlink channel.

In a particular embodiment, the indication is transmitted to the UE via RRC signaling.

In a particular embodiment, determining whether to activate or deactivate WUR monitoring by the UE for a downlink channel includes comparing at least one value associated with the at least one UE mobility measurement to a threshold. When the at least one value associated with the at least one UE mobility measurement is above the threshold, the network node determines to activate WUR monitoring by the UE for the downlink channel.

In a particular embodiment, determining whether to activate or deactivate WUR monitoring by the UE for the downlink channel includes comparing at least one value associated with the at least one UE mobility measurement to a threshold. When the at least one value associated with the at least one UE mobility measurement is below the threshold, the network node determines not to perform to deactivate WUR monitoring by the UE for the downlink channel.

In a particular embodiment, the at least one UE mobility measurement is received in a measurement report.

In a particular embodiment, the indication comprises a handover command to initiate handover of the UE from a source cell to a target cell, wherein at least one of the source cell and the target cell are a WUR cell.

In a further particular embodiment, the target cell comprises a primary serving cell and/or a parent of a WUR cell.

In a particular embodiment, the at least one measurement comprises at least one of: at least one value associated with a low power-wake up signal, LP-WUS, measurement; at least one value associated with at least one Reference Signal Received Power measurement; at least one value associated with at least one Reference Signal Received Quality measurement; at least one value associated with at least one Channel State Information measurement; at least one value associated with at least one Signal Interference to Noise Ratio measurement; and/or at least one value associated with at least one Signal Noise Ratio measurement.

In a particular embodiment, the network node transmits, to the UE, a measurement configuration information, and wherein the at least one measurement is based on the measurement configuration information.

In a particular embodiment, the network node transmits, to the UE, a measurement reporting configuration comprising at least one WUR reporting criteria. The at least one measurement is received from the UE based on the at least one reporting criteria being met.

In a further particular embodiment, the at least one WUR reporting criteria comprises at least one of: a value associated with the at least one measurement is greater than at least one first threshold; a value associated with the at least one measurement is less than at least one second threshold; a number of values associated with the at least one measurement are greater than at least one third threshold; a number of values associated with the at least one measurement are less than at least one fourth threshold; a value or a number of values associated with the at least one measurement are greater than at least one fifth threshold for an amount of time that is equal to or more than a minimum duration of time; and a value or a number of values associated with the at least one measurement are less than at least one sixth threshold for an amount of time that is equal to or more than a minimum duration of time.

In a particular embodiment, the network node receives, from the UE, information indicating a capability of the UE to perform WUR monitoring.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

### Group A Example Embodiments

Example Embodiment A1. A method performed by a user equipment comprising: any of the user equipment steps, features, or functions described above, either alone or in combination with other steps, features, or functions described above.
Example Embodiment A2. The method of the previous embodiment, further comprising one or more additional user equipment steps, features or functions described above.
Example Embodiment A3. The method of any of the previous embodiments, further comprising: providing user data; and forwarding the user data to a host computer via the transmission to the network node.

### Group B Example Embodiments

Example Embodiment B1. A method performed by a network node comprising: any of the network node steps, features, or functions described above, either alone or in combination with other steps, features, or functions described above.
Example Embodiment B2. The method of the previous embodiment, further comprising one or more additional network node steps, features or functions described above.
Example Embodiment B3. The method of any of the previous embodiments, further comprising: obtaining user data; and forwarding the user data to a host or a user equipment.

### Group C Example Embodiments

Example Embodiment C1. A method performed by a user equipment (UE) comprising at least one of: transmitting, to a network node, at least one measurement associated with a Wake-Up Radio (WUR) cell; and/or transmitting, to the network node, an indication that at least one WUR cell has been deconfigure and/or released.
Example Embodiment C2. The method of Example Embodiment C1, wherein the WUR cell is within or at least partially overlaps with a cell in which the UE is served by the network node.
Example Embodiment C3. The method of Example Embodiment C2, wherein a cell identifier associated with the WUR cell is the same as a cell identifier associate with the cell in which the UE is served by the network node.
Example Embodiment C4. The method of Example Embodiment C2, wherein a first cell identifier associated with the WUR cell is different from a second cell identifier associate with the cell in which the UE is served by the network node.
Example Embodiment C5. The method of Example Embodiment C4, comprising receiving, from the network node, the first cell identifier associated with the WUR cell in a low-power sync signal and/or as part of a low power-Wake Up Signal (LP-WUS).
Example Embodiment C6. The method of any one of Example Embodiments C2 to C5, wherein the at least one measurement associated with the WUR cell is received in a measurement report comprising at least one additional measurement associated with the cell.
Example Embodiment C7. The method of any one of Example Embodiments C2 to C6, wherein the WUR cell is a WUR cell in which the UE is located.
Example Embodiment C8. The method of any one of Example Embodiments C2 to C6, wherein the WUR cell is a neighboring WUR cell that neighbors and/or is adjacent to and/or is proximate to another WUR cell in which the UE is located.
Example Embodiment C9. The method of any one of Example Embodiments C1 to C8, wherein the UE is in a RRC connected state.
Example Embodiment C10. The method of any one of Example Embodiments C1 to C9, comprising receiving, from the network node or another network node, configuration information for measurement reporting, and wherein the at least one measurement is received based on the configuration information for measurement reporting.
Example Embodiment C11. The method of any one of Example Embodiments C1 to C10, wherein the at least one measurement associated with the WUR cell comprises at least one of: at least one value associated with a low power-wake up signal (LP-WUS) measurement; at least one value associated with at least one RSRP measurement; at least one value associated with at least one RSRQ measurement; at least one value associated with at least one Channel State Information measurement; at least one value associated with at least one SINR measurement; and/or at least one value associated with at least one SNR measurement.
Example Embodiment C12. The method of any one of Example Embodiments C1 to C11, comprising: determining that at least one reporting criteria is met, and wherein the at least one measurement is transmitted based on the at least one reporting criteria being met.
Example Embodiment C13. The method of Example Embodiment D12, comprising receiving the at least one reporting criteria from the network node or another network node.
Example Embodiment C14. The method of any one of Example Embodiments C12 to C13, wherein the at least one reporting criteria comprises at least one of: a value associated with the at least one measurement is greater than (or greater than or equal to) at least one first threshold; a value associated with the at least one measurement is less than (or less than or equal to) at least one second threshold; a number of values associated with the at least one measurement are greater than (or greater than or equal to) at least one third threshold; a number of values associated with the at least one measurement are less than (or less than or equal to) at least one fourth threshold; a value or a number of values associated with the at least one measurement are greater than (or greater than or equal to) at least one fifth threshold for an amount of time that is equal to or more than a minimum duration of time; and a value or a number of values associated with the at least one measurement are less than (or less than or equal to) at least one sixth threshold for an amount of time that is equal to or more than a minimum duration of time.
Example Embodiment C15. The method of any one of Example Embodiments C1 to C14, comprising: receiving, from the network node, a signal to initiate a handover to or from the WUR cell.
Example Embodiment C16. The method of Example Embodiment C15, wherein the signal to initiate the handover is received from the network node based on at least one handover criteria being met.
Example Embodiment C17. The method of Example Embodiment C16, wherein the at least one handover criteria comprises at least one of: a value associated with the at least one measurement is greater than (or greater than or equal to) the at least one seventh threshold; a value associated with the at least one measurement is less than (or less than or equal to) at least one eighth threshold; a number of values associated with the at least one measurement are greater than (or greater than or equal to) at least one nineth threshold; a number of values associated with the at least one measurement are less than (or less than or equal to) at least one tenth threshold; a value or a number of values associated with the at least one measurement are greater than (or greater than or equal to) at least one eleventh threshold for an amount of time that is equal to or more than a minimum duration of time; and a value or a number of values associated with the at least one measurement are less than (or less than or equal to) at least one twelfth threshold for an amount of time that is equal to or more than a minimum duration of time.
Example Embodiment C18. The method of any one of Example Embodiments C15 to C17, wherein the at least one signal to initiate the handover comprises a handover command to initiate the handover of the UE from another cell to the WUR cell.
Example Embodiment C19. The method of any one of Example Embodiments C15 to C18, wherein the at least one signal to initiate the handover comprises a handover command to initiate the handover of the UE from the WUR cell to another cell.
Example Embodiment C20. The method of any one of Example Embodiments C18 to C19, wherein the another cell comprises another WUR cell.
Example Embodiment C21. The method of any one of Example Embodiments C18 to C19, wherein the another cell comprises a primary serving cell.
Example Embodiment C22. The method of any one of Example Embodiments C18 to C19, wherein the another cell comprises a cell that is a parent cell of the WUR cell.
Example Embodiment C23. The method of any one of Example Embodiments C1 to C22, comprising receiving, from the network node or another network node, configuration information configuring the UE to autonomously determine when the UE is out of coverage area of the WUR cell and deconfigure and/or release the WUR cell.
Example Embodiment C24. The method of Example Embodiment C23, comprising, based on the configuration information, periodically checking whether the UE has moved out of the coverage area of the WUR cell.
Example Embodiment C25. The method of any one of Example Embodiments C23 to C24, comprising, based on the configuration information, determining that the UE has moved out of the coverage area of the WUR cell when at least one measurement associated with the WUR cell is below (or equal to or below) a minimum threshold.
Example Embodiment C26. The method of any one of Example Embodiments C1 to C25, comprising transmitting, to the network node, information indicating a capability of the UE to operate in and/or measure a WUR cell.
Example Embodiment C27. The method of Example Embodiments C1 to C26, further comprising: providing user data; and forwarding the user data to a host via the transmission to the network node.
Example Embodiment C28. A user equipment comprising processing circuitry configured to perform any of the methods of Example Embodiments C1 to C27.
Example Embodiment C29. A user equipment configured to perform any of the methods of Example Embodiments C1 to C27.
Example Embodiment C30. A wireless device comprising processing circuitry configured to perform any of the methods of Example Embodiments C1 to C27.
Example Embodiment C31. A computer program comprising instructions which when executed on a computer perform any of the methods of Example Embodiments C1 to C27.
Example Embodiment C32. A computer program product comprising computer program, the computer program comprising instructions which when executed on a computer perform any of the methods of Example Embodiments C1 to C27.
Example Embodiment C33. A non-transitory computer readable medium storing instructions which when executed by a computer perform any of the methods of Example Embodiments C1 to 27.

### Group D Example Embodiments

Example Embodiment D1. A method performed by a network node, the method comprising at least one of: receiving, from a User Equipment (UE), at least one measurement associated with a Wake-Up Radio (WUR) cell; and/or receiving, for the UE, an indication that at least one WUR cell has been deconfigure and/or released.
Example Embodiment D2. The method of Example Embodiment D1, wherein the WUR cell is within or at least partially overlaps with a cell in which the UE is served by the network node.
Example Embodiment D3. The method of Example Embodiment D2, wherein a cell identifier associated with the WUR cell is the same as a cell identifier associate with the cell in which the UE is served by the network node.
Example Embodiment D4. The method of Example Embodiment D2, wherein a first cell identifier associated with the WUR cell is different from a second cell identifier associate with the cell in which the UE is served by the network node.
Example Embodiment D5. The method of Example Embodiment D4, comprising transmitting, to the UE, the first cell identifier associated with the WUR cell in a low-power sync signal and/or as part of a low power-Wake Up Signal (LP-WUS).
Example Embodiment D6. The method of any one of Example Embodiments D2 to D5, wherein the at least one measurement associated with the WUR cell is received in a measurement report comprising at least one additional measurement associated with the cell.
Example Embodiment D7. The method of any one of Example Embodiments D2 to D6, wherein the WUR cell is a WUR cell in which the UE is located.
Example Embodiment D8. The method of any one of Example Embodiments D2 to D6, wherein the WUR cell is a neighboring WUR cell that neighbors and/or is adjacent to and/or is proximate to another WUR cell in which the UE is located.
Example Embodiment D9. The method of any one of Example Embodiments D1 to D8, wherein the UE is in a RRC connected state.
Example Embodiment D10. The method of any one of Example Embodiments D1 to D9, comprising transmitting, to the UE, configuration information for measurement reporting, and wherein the at least one measurement is received based on the configuration information for measurement reporting.
Example Embodiment D11. The method of any one of Example Embodiments D1 to D10, wherein the at least one measurement associated with the WUR cell comprises at least one of: at least one value associated with a low power-wake up signal (LP-WUS) measurement; at least one value associated with at least one RSRP measurement; at least one value associated with at least one RSRQ measurement; at least one value associated with at least one Channel State Information measurement; at least one value associated with at least one SINR measurement; and/or at least one value associated with at least one SNR measurement.
Example Embodiment D12. The method of any one of Example Embodiments D1 to D11, wherein the at least one measurement is received based on at least one reporting criteria being met.
Example Embodiment D13. The method of Example Embodiment D12, comprising transmitting the at least one reporting criteria to the UE.
Example Embodiment D14. The method of any one of Example Embodiments D12 to D13, wherein the at least one reporting criteria comprises at least one of: a value associated with the at least one measurement is greater than (or greater than or equal to) at least one first threshold; a value associated with the at least one measurement is less than (or less than or equal to) at least one second threshold; a number of values associated with the at least one measurement are greater than (or greater than or equal to) at least one third threshold; a number of values associated with the at least one measurement are less than (or less than or equal to) at least one fourth threshold; a value or a number of values associated with the at least one measurement are greater than (or greater than or equal to) at least one fifth threshold for an amount of time that is equal to or more than a minimum duration of time; and a value or a number of values associated with the at least one measurement are less than (or less than or equal to) at least one sixth threshold for an amount of time that is equal to or more than a minimum duration of time.
Example Embodiment D15. The method of any one of Example Embodiments D1 to D14, comprising: based on the at least one measurement, transmitting a signal to initiate a handover to or from the WUR cell.
Example Embodiment D16. The method of Example Embodiment D15, wherein the signal to initiate the handover is transmitted to the UE based on at least one handover criteria being met.
Example Embodiment D17. The method of Example Embodiment D16, wherein the at least one handover criteria comprises at least one of: a value associated with the at least one measurement is greater than (or greater than or equal to) the at least one seventh threshold; a value associated with the at least one measurement is less than (or less than or equal to) at least one eighth threshold; a number of values associated with the at least one measurement are greater than (or greater than or equal to) at least one nineth threshold; a number of values associated with the at least one measurement are less than (or less than or equal to) at least one tenth threshold; a value or a number of values associated with the at least one measurement are greater than (or greater than or equal to) at least one eleventh threshold for an amount of time that is equal to or more than a minimum duration of time; and a value or a number of values associated with the at least one measurement are less than (or less than or equal to) at least one twelfth threshold for an amount of time that is equal to or more than a minimum duration of time.
Example Embodiment D18. The method of any one of Example Embodiments D15 to D17, wherein the at least one signal to initiate the handover comprises a handover command to initiate the handover of the UE from another cell to the WUR cell.
Example Embodiment D19. The method of any one of Example Embodiments D15 to D18, wherein the at least one signal to initiate the handover comprises a handover command to initiate the handover of the UE from the WUR cell to another cell.
Example Embodiment D20. The method of any one of Example Embodiments D18 to D19, wherein the another cell comprises another WUR cell.
Example Embodiment D21. The method of any one of Example Embodiments D18 to D19, wherein the another cell comprises a primary serving cell.
Example Embodiment D22. The method of any one of Example Embodiments D18 to D19, wherein the another cell comprises a cell that is a parent cell of the WUR cell.
Example Embodiment D23. The method of any one of Example Embodiments D1 to D22, comprising transmitting configuration information to the UE, wherein the configuration information configures the UE to autonomously determine when the UE is out of coverage area of the WUR cell and deconfigure and/or release the WUR cell.
Example Embodiment D24. The method of Example Embodiment D23, wherein the configuration information configures the UE to periodically check whether the UE has moved out of the coverage area of the WUR cell.
Example Embodiment D25. The method of any one of Example Embodiments D23 to D24, wherein the configuration information configures the UE to determine that the UE has moved out of the coverage area of the WUR cell when at least one measurement associated with the WUR cell is below (or equal to or below) a minimum threshold.
Example Embodiment D26. The method of any one of Example Embodiments D1 to D25, comprising receiving, from the UE, information indicating a capability of the UE to operate in and/or measure a WUR cell.
Example Embodiment D27. The method of any one of Example Embodiments D1 to D26, wherein the network node comprises a gNodeB (gNB).
Example Embodiment D28. The method of any one of Example Embodiments D1 to D27, further comprising. obtaining user data; and forwarding the user data to a host or a user equipment.
Example Embodiment D29. A network node comprising processing circuitry configured to perform any of the methods of Example Embodiments D1 to D28.
Example Embodiment D30. A network node configured to perform any of the methods of Example Embodiments D1 to D28.
Example Embodiment D31. A computer program comprising instructions which when executed on a computer perform any of the methods of Example Embodiments D1 to D28.
Example Embodiment D32. A computer program product comprising computer program, the computer program comprising instructions which when executed on a computer perform any of the methods of Example Embodiments D1 to D28.
Example Embodiment D33. A non-transitory computer readable medium storing instructions which when executed by a computer perform any of the methods of Example Embodiments D1 to D28.

### Group E Example Embodiments

Example Embodiment E1. A user equipment comprising: processing circuitry configured to perform any of the steps of any of the Group A and C Example Embodiments; and power supply circuitry configured to supply power to the processing circuitry.
Example Embodiment E2. A network node comprising: processing circuitry configured to perform any of the steps of any of the Group B and D Example Embodiments; power supply circuitry configured to supply power to the processing circuitry.
Example Embodiment E3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.
Example Embodiment E5. The host of the previous Example Embodiment, wherein the cellular network further includes a network node configured to communicate with the UE to transmit the user data to the UE from the host.
Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.
Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.
Example Embodiment E8. The method of the previous Example Embodiment, further comprising: at the host, executing a host application associated with a client application executing on the UE to receive the user data from the UE.
Example Embodiment E9. The method of the previous Example Embodiment, further comprising: at the host, transmitting input data to the client application executing on the UE, the input data being provided by executing the host application, wherein the user data is provided by the client application in response to the input data from the host application.
Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.
Example Embodiment E11. The host of the previous Example Embodiment, wherein the cellular network further includes a network node configured to communicate with the UE to transmit the user data from the UE to the host.
Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.
Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.
Example Embodiment E14. The method of the previous Example Embodiment, further comprising: at the host, executing a host application associated with a client application executing on the UE to receive the user data from the UE.
Example Embodiment E15. The method of the previous Example Embodiment, further comprising: at the host, transmitting input data to the client application executing on the UE, the input data being provided by executing the host application, wherein the user data is provided by the client application in response to the input data from the host application.
Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.
Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.
Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.
Example Embodiment E19. The method of the previous Example Embodiment, further comprising, at the network node, transmitting the user data provided by the host for the UE.
Example Embodiment E20. The method of any of the previous 2 Example Embodiments, wherein the user data is provided at the host by executing a host application that interacts with a client application executing on the UE, the client application being associated with the host application.
Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.
Example Embodiment E22. The communication system of the previous Example Embodiment, further comprising: the network node; and/or the user equipment.
Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.
Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.
Example Embodiment E25. The host of the any of the previous 2 Example Embodiments, wherein the initiating receipt of the user data comprises requesting the user data.
Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.
Example Embodiment E27. The method of the previous Example Embodiment, further comprising at the network node, transmitting the received user data to the host.

1. A method performed by a user equipment, UE comprising:
while the UE is in a Radio Resource Control, RRC, connected state and is configured for Wake-up Receiver, WUR, performing at least one UE mobility measurement; and
based on the at least one UE mobility measurement, determining whether to perform WUR monitoring for a downlink channel.

2. The method of claim 1, wherein determining whether to perform WUR monitoring for the downlink channel comprises:
comparing at least one value associated with the at least one UE mobility measurement to a threshold;
when the at least one value associated with the at least one UE mobility measurement is above the threshold, determining to perform WUR monitoring for the downlink channel.

3. (canceled)

4. The method of claim 1, wherein determining whether to perform WUR monitoring for the downlink channel comprises:
comparing at least one value associated with the at least one UE mobility measurement to a threshold; and
when the at least one value associated with the at least one UE mobility measurement is below the threshold, determining not to perform WUR monitoring for the downlink channel.

5. The method of claim 4, comprising monitoring the downlink channel using non-WUR monitoring.

6. The method of claim 2, comprising receiving, from a network node, configuration information configuring the UE to autonomously determine whether or not to perform WUR monitoring for the downlink channel.

7. The method of claim 1, wherein determining whether to perform WUR monitoring for the downlink channel comprises:
transmitting to the network node, the at least one value associated with the at least one UE mobility measurement, and
receiving, from the network node, an indication to monitor the downlink channel using WUR monitoring or non-WUR monitoring.

8. (canceled)

9. The method of claim 1, wherein determining whether to perform WUR monitoring for the downlink channel comprises:
transmitting to the network node, the at least one value associated with the at least one UE mobility measurement, and
receiving, from the network node, a signal to initiate a handover to or from the WUR cell.

10. The method of claim 9, wherein the at least one signal to initiate the handover comprises a handover command to initiate the handover of the UE from a source cell to a target cell, wherein at least one of the source cell and the target cell are a WUR cell.

11. (canceled)

12. The method of claim 1, wherein the at least one measurement comprises at least one of:
at least one value associated with a low power-wake up signal, LP-WUS, measurement;
at least one value associated with at least one Reference Signal Received Power measurement;
at least one value associated with at least one Reference Signal Received Quality measurement;
at least one value associated with at least one Channel State Information measurement;
at least one value associated with at least one Signal Interference to Noise Ratio measurement; and/or
at least one value associated with at least one Signal Noise Ratio measurement.

13. (canceled)

14. The method of claim 1, comprising:
receiving, from the network node or another network node, a measurement reporting configuration comprising at least one WUR reporting criteria; and
determining that the at least one WUR reporting criteria is met, and
wherein the at least one measurement is transmitted to the network node based on the at least one reporting criteria being met.

15. The method of claim 14, wherein the at least one WUR reporting criteria comprises at least one of:
a value associated with the at least one measurement is greater than at least one first threshold;
a value associated with the at least one measurement is less than at least one second threshold;
a number of values associated with the at least one measurement are greater than at least one third threshold;
a number of values associated with the at least one measurement are less than at least one fourth threshold;
a value or a number of values associated with the at least one measurement are greater than at least one fifth threshold for an amount of time that is equal to or more than a minimum duration of time; and
a value or a number of values associated with the at least one measurement are less than at least one sixth threshold for an amount of time that is equal to or more than a minimum duration of time.

16. The method of claim 1, comprising transmitting, to the network node, information indicating a capability of the UE to perform WUR monitoring.

17. A method performed by a network node the method comprising:
receiving from a User Equipment, UE that is in a Radio Resource Control, RRC, connected state and is configured for Wake-up Receiver, WUR, at least one UE mobility measurement;
based on a comparison of a value associated with the at least one UE mobility measurement to a threshold, determining whether to activate or deactivate WUR monitoring by the UE for a downlink channel; and
transmitting, to the UE, an indication of whether to activate or deactivate WUR monitoring by the UE for the downlink channel.

18. (canceled)

19. The method of claim 17, wherein determining whether to activate or deactivate WUR monitoring by the UE for a downlink channel comprises:
comparing at least one value associated with the at least one UE mobility measurement to a threshold;
when the at least one value associated with the at least one UE mobility measurement is above the threshold, determining to activate WUR monitoring by the UE for the downlink channel.

20. The method of claim 17, wherein determining whether to activate or deactivate WUR monitoring by the UE for the downlink channel comprises:
comparing at least one value associated with the at least one UE mobility measurement to a threshold; and
when the at least one value associated with the at least one UE mobility measurement is below the threshold, determining not to perform to deactivate WUR monitoring by the UE for the downlink channel.

21. (canceled)

22. The method of claim 17, wherein the indication comprises a handover command to initiate handover of the UE from a source cell to a target cell, wherein at least one of the source cell and the target cell are a WUR cell.

23. (canceled)

24. The method of claim 17, wherein the at least one measurement comprises at least one of:
at least one value associated with a low power-wake up signal, LP-WUS, measurement;
at least one value associated with at least one Reference Signal Received Power measurement;
at least one value associated with at least one Reference Signal Received Quality measurement;
at least one value associated with at least one Channel State Information measurement;
at least one value associated with at least one Signal Interference to Noise Ratio measurement; and/or
at least one value associated with at least one Signal Noise Ratio measurement.

25. (canceled)

26. The method of claim 17, comprising:
transmitting, to the UE, a measurement reporting configuration comprising at least one WUR reporting criteria; and
wherein the at least one measurement is received from the UE based on the at least one reporting criteria being met.

27. The method of claim 26, wherein the at least one WUR reporting criteria comprises at least one of:
a value associated with the at least one measurement is greater than at least one first threshold;
a value associated with the at least one measurement is less than at least one second threshold;
a number of values associated with the at least one measurement are greater than at least one third threshold;
a number of values associated with the at least one measurement are less than at least one fourth threshold;
a value or a number of values associated with the at least one measurement are greater than at least one fifth threshold for an amount of time that is equal to or more than a minimum duration of time; and
a value or a number of values associated with the at least one measurement are less than at least one sixth threshold for an amount of time that is equal to or more than a minimum duration of time.

28. The method of claim 27, comprising receiving, from the UE, information indicating a capability of the UE to perform WUR monitoring.

29. A user equipment, UE configured to perform at least one of:
while the UE is in a Radio Resource Control, RRC, connected state and is configured for Wake-up Receiver, WUR, performing at least one UE mobility measurement; and
based on the at least one UE mobility measurement, determining whether to perform WUR monitoring for a downlink channel.

30. (canceled)

31. A network node configured to perform at least one of:
receiving, from a User Equipment, UE, that is in a Radio Resource Control, RRC, connected state and is configured for Wake-up Receiver, WUR, at least one UE mobility measurement;
based on a comparison of a value associated with the at least one UE mobility measurement to a threshold, determining whether to activate or deactivate WUR monitoring by the UE for a downlink channel;
transmitting, to the UE, an indication of whether to activate or deactivate WUR monitoring by the UE for the downlink channel.

32. (canceled)
